(19) United States
(12) Patent Application Publication
(10) Pub. No.: US 2021/0164289 A1
(43) Pub. Date: Jun. 3, 2021

(54) STORM COVER FOR BUILDING OPENINGS SUCH AS THROUGH THE WALL AIR CONDITIONING (PTAC) OPENING

(71) Applicant: Frederick Kolek, Woodland Park, NJ (US)

(72) Inventor: Frederick Kolek, Woodland Park, NJ (US)

(21) Appl. No.: 17/247,175

(22) Filed: Dec. 2, 2020

Related U.S. Application Data
(60) Provisional application No. 62/942,531, filed on Dec. 2, 2019.

(51) Int. Cl. E06B 5/10; F24F 13/20

(52) U.S. Cl. CPC E06B 5/10; F24F 13/20

(57) ABSTRACT

A cover assembly is constructed and arranged for secure, removable installation over any suitable wall opening. The cover assembly may comprise a cover operably connected to a cover securement component. The cover securement component may be a strap and a strap ratchet. The cover assembly is constructed and arranged for installation over an opening such as a wall PTAC sleeve. The cover securement component may further comprise a strap attachment panel affixed to the cover, the strap ratchet being constructed and arranged to retain and secure the strap. In use, the strap may extend around and hold the cover in place. The present invention provides a solution that is easily and quickly installed, and may be conveniently stored. The cover assembly of the present invention may therefore provide convenience, effectiveness and cost savings due to effective damage prevention and re-use.

### CROSS-REFERENCE TO RELATED APPLICATION

This application claims the benefit of priority of U.S. provisional application No. 62/942,531, filed 2 Dec. 2019, the contents of which are herein incorporated by reference.

### BACKGROUND OF THE INVENTION

The present invention relates air conditioning and more particularly to a storm cover for through the wall air conditioning (PTAC).

There are no effective options which are capable of stopping intrusion of water, wind, snow or the like into homes during hurricanes, storms and other minor or major weather events, which may enter a home or building through wall air conditioning unit (PTAC) openings, sleeves or windows.

Cutting plastic or a tarp and covering with a plastic sheet or tarp with duct tape or rope to cover such an opening when a need arises is cumbersome, difficult, inconvenient, and ultimately ineffective and wasteful. Application of a makeshift plastic sheet or tarp to a wet, dirty surface, results in ineffective protection that is not capable of withstanding prolonged exposure so it will fail to protect the home or building from damage and will ultimately be thrown away.

Accordingly, there is a need for a solution to at least one of the aforementioned problems which is capable of protecting a home from the elements.

### SUMMARY OF THE INVENTION

Advantageously, in one aspect, the present invention provides a solution which provides a cover for building openings, windows, air conditioning units or the like, capable of protecting the home from incoming water, wind, snow or the like from any event, such as for example without limitation, minor or major weather events.

In one aspect, the present invention may comprise a cover assembly constructed and arranged for secure, removable installation over an opening in a building or wall. The cover assembly may be of any suitable shape or dimensions. In one aspect, the cover assembly may comprise a cover of any shape and any suitable dimensions operably connected to a cover securement component. The cover may comprise a front panel and at least one side panel.

In a further aspect, the cover assembly may comprise a rectangular cover operably connected to a cover securement component, the cover assembly being constructed and arranged for installation over a wall PTAC sleeve. The cover may comprise a rectangular front panel, a top side panel, a right side panel, a left side panel and a bottom side panel.

In one aspect, the cover securement component may be any suitable device. In a further aspect, the cover securement component may comprise a strap and a strap ratchet. In a further aspect, the cover securement component may further comprise a strap attachment panel affixed to a side panel of the cover.

In a further aspect, the cover securement component may comprise a strap, a strap attachment panel affixed to a rectangular cover, and a strap ratchet constructed and arranged to retain and secure the strap. In use, the strap may extend around the rectangular cover and hold the cover assembly in place. The present invention provides a solution that is easy to install, and may further be easily stored for convenient storage, access and use. In use, the present invention is easily and quickly installed. The present invention will therefore provide convenience, effectiveness and cost savings due to effective damage prevention and re-use.

These and other features, aspects and advantages of the present invention will become better understood with reference to the following drawings, description and claims.

### BRIEF DESCRIPTION OF THE DRAWINGS

The preferred embodiment of the claimed subject matter will hereinafter be described in conjunction with the appended drawings provided to illustrate and not to limit the scope of the claimed subject matter, where like designations denote like elements, and in which:

FIG. 1 is a perspective view an exemplary embodiment of the present invention, shown in-use;

FIG. 2 is a perspective view of an exemplary embodiment of the present invention;

FIG. 3 is a section view taken along line 3-3 from FIG. 1, enlarged to show detail;

FIG. 4 is a section view taken along line 4-4 from FIG. 3, enlarged to show further detail; and

FIG. 5 is an exploded view of the invention.

It is to be understood that like reference numerals refer to like parts throughout the several views of the drawings.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

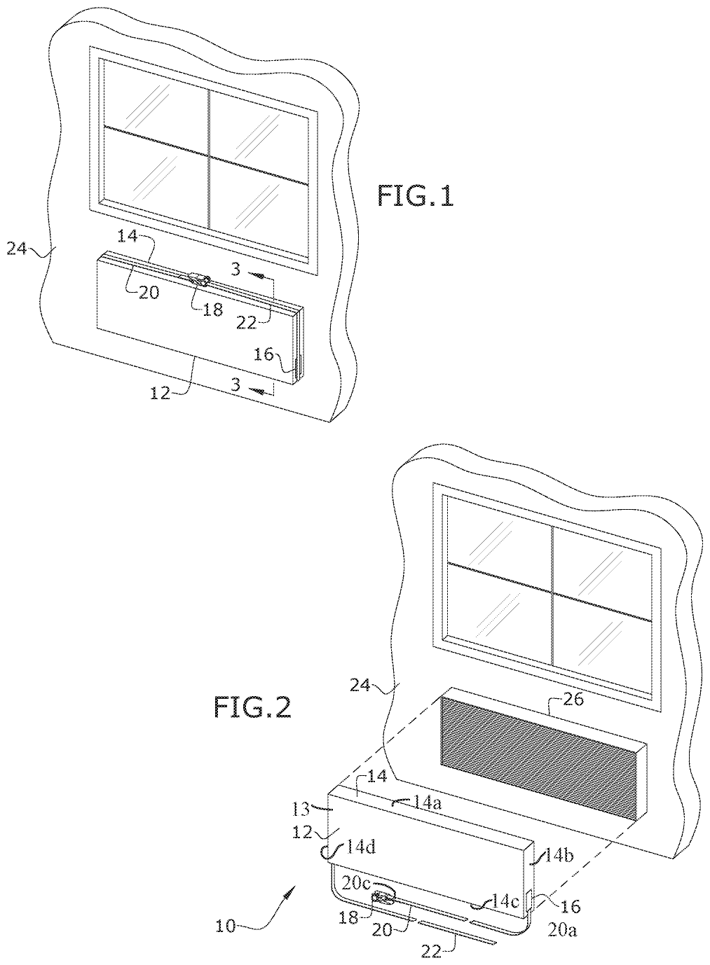

As used herein, “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, as there is no intention to be bound by any express or implied theory presented in the preceding technical field, background, brief summary or the following detailed description, it is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Broadly, one embodiment of the present invention provides a storm cover for an opening in a building. The opening may be located in a building, in locations such as, for example without limitation, a building wall, a window air conditioning unit, a split A/C unit, an Air Handler an Exhaust or Intake Unit, or the like. The storm cover may be beneficially installed over an opening for a through the wall air conditioning (PTAC) or the like.

The inventive cover assembly constructed and arranged to stop water intrusion during a storm into a through the wall air conditioning unit (PTAC). In an exemplary embodiment, the present invention provides a water proof cover which may be placed over the unit sleeve and secured by a cover securement component to keep it secure during driving rain and wind and keep it water tight.

The present invention differs from and distinguishes over current options, providing an unprecedented solution to the problem of water intrusion through a wall air conditioning unit during a storm.

In an exemplary embodiment the present invention may comprise a cover assembly constructed and arranged for secure, removable installation over a wall PTAC sleeve. The cover assembly may comprise a rectangular cover operably connected to a cover securement component. The cover securement component may be any suitable device, such as, for example without limitation, a strap and a strap ratchet. The cover assembly is constructed and arranged for installation over the wall PTAC sleeve. The rectangular cover may comprise an exterior portion, an interior portion, a rectangular front panel, and a plurality of side panels extending perpendicularly from the rectangular front panel. The plurality of side panels may further comprise a top side panel, a right side panel, a left side panel and a bottom side panel. In an exemplary embodiment, the cover securement component may comprise a strap, a strap attachment panel affixed to one of said plurality of side panels of the rectangular cover, the strap attachment panel operably connected to a first strap end of the strap, and a strap ratchet constructed and arranged to retain and secure the strap. In use, the strap may extend around the plurality of side panels of the rectangular cover and hold the cover assembly in place around the PTAC sleeve.

In an exemplary embodiment, the present invention may provide a cover assembly comprising one or more of the following elements or components and combinations thereof.

1. a rectangular cover made of high density polyethylene material constructed and arranged to provide a rectangular cover over a wall PTAC sleeve. It is understood that the cover may be any shape or any suitable dimensions or sizes, and may be constructed and arranged to cover any area, such as for example without limitation, a window air conditioning unit, a split A/C unit, an Air Handler an Exhaust or Intake Unit, or the like. In one embodiment, the cover may be polyethylene cut to specific size for application PTAC cover which may be an approximate 43×18×3 rectangular form with lip to cover area which protrudes from building, then attach straps long enough to wrap around unit and add ratchet clasp to secure.

2. a nylon strap secured to the cover. The nylon strap may be secured to a surface of the cover by any suitable means or method so that it may in use be wrapped around the unit when installed to secure the cover to the PTAC sleeve.

3. a ratchet device attached to the strap which may be used to tighten the cover around the sleeve to keep it secure during driving rain and wind and keep it water tight.

In an exemplary embodiment, the present invention may comprise one or more of the following elements or components and combinations thereof.

1. a rectangular cover constructed and arranged to cover a through the wall PTAC sleeve. The cover may be made of any suitable material by any suitable fabrication process, and may be provided in any suitable size or dimensions to accommodate any existing through the wall PTAC sleeve. The rectangular cover may have a rectangular front panel and side panels extending perpendicularly from the rectangular front panel. The side panels may comprise a top side panel, a right side panel, a left side panel and a bottom side panel. The cover may be made to size, or custom made.

2. a strap of any suitable dimensions made of any suitable material may be added. The strap may be constructed and arranged to wrap around the cover side panels, the air conditioning unit and unit when installed to secure it to the sleeve.

3. a custom ratchet device may be attached to the strap, which may be used to tighten and secure the cover around the wall PTAC sleeve to keep it secure during driving rain and wind and keep it water tight.

The present invention provides a cover assembly that is capable of being quickly and easily installed by a two-step process of placement over an area to be covered, and securement in place with the securement element. Between uses the cover assembly may be foldable and may be easily stored.

In an exemplary embodiment, the present invention may include a method that comprises one or more of the following elements or steps, and combinations thereof.

1. The cover component is removed from a package and placed over a PTAC unit (air conditioner).

2. A securement component is wrapped around the cover component, secured and tightened to secure the cover in place.

3. Upon need during inclement weather the cover and securement component would be installed over the PTAC or (Air condition) unit, and after a storm or other event, the cover assembly would be removed by loosening the securement component, folding the cover and storing the cover assembly for storage until the next use.

Referring to the drawings, particularly to FIG. 1, in an exemplary embodiment, the present invention provides a storm cover assembly, referred to generally at 10. The storm cover assembly 10 may comprise a cover 12 having an exterior portion and an interior portion. The storm cover assembly 10 may comprise a front panel 13, and a side panel 14.

As shown at FIG. 2, in an exemplary embodiment, the side panel may comprise a top side panel 14a, a right side panel 14b, a left side panel 14c and a bottom side panel 14d.

With reference to FIGS. 1-2, the storm cover assembly 10 may further comprise a securement element. The securement element may comprise an attachment assembly which may comprise a first strap attachment panel 16, a strap ratchet 18 and a strap 20. The strap 20 may comprise a first strap portion 20a attached to the first strap attachment panel 16.

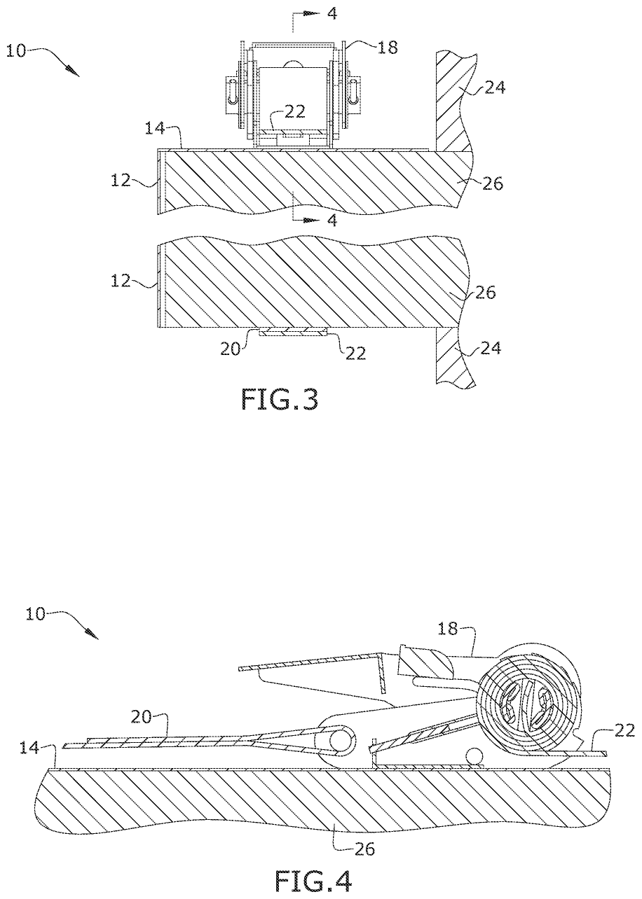

FIG. 3 is a section view taken along line 3-3 from FIG. 1, enlarged to show detail. FIG. 4 is a section view taken along line 4-4 from FIG. 3, further enlarged to show further detail of the construction of the ratchet 18 and strap 20 of the securement assembly.

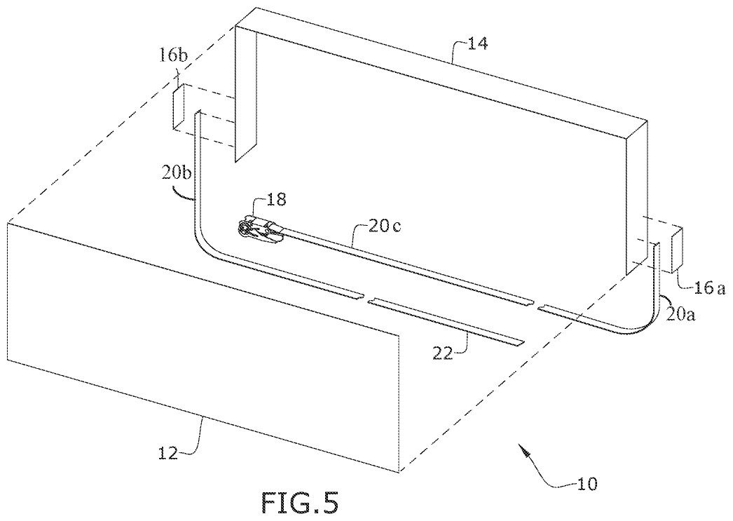

As best seen at FIG. 5, the attachment assembly may further comprise a second strap portion 20b attached to a second strap attachment panel 16b. The strap 20 may further comprise a third strap portion 20c attached to the ratchet 18. The strap attachment panels 16a-b are fixed to the side panel 14. In one embodiment, the first strap attachment panel 16a is attached to the right side panel 14b, and the second strap attachment panel 16b is attached to the left side panel 14c. It can be seen that the strap attachment panels 16a-b may be attached to any portion of the side panel 14.

In use, the cover assembly 10 may be installed on any air conditioner unit. A house wall 24 may have a wall air conditioner unit 26 installed in a wall or window thereof. The cover assembly 10 may be installed on an air conditioner unit 26 by placing the cover 12 over the air conditioner unit 26, and wrapping an open strap portion 22 of the strap 20 around the cover 12 and securing the strap by using the strap ratchet 18 to tighten and fixedly retain the cover assembly 10 on the air conditioner 26.

In an exemplary embodiment the present invention may be installed by easily sliding the cover assembly over the through the wall sleeve or other structure on which it is being installed, and secured thereto by the strap encircling the cover assembly side panels over the wall sleeve, and engaging the ratchet to tighten the strap around the cover and wall sleeve for a secure, water tight fit.

The cover and elements thereof may be made of any suitable material by any suitable fabrication method.

In an exemplary embodiment, the cover assembly may be made of polyethylene material, nylon strap and a ratchet. The polyethylene material may be cut to a proper size and the edges may be folded to create edges to fit onto the PTAC sleeve. Fold over seams may be applied along all edges for strength. Nylon straps may be provided and attached to encircle the cover over the edge of the sleeve. The straps may crisscross the cover over the edge of the sleeve. A ratchet may be secured at an end of the strap to secure the cover when installed.

All described elements of the cover assembly are necessary in order for it to function properly. None of these items are optional,

In an exemplary embodiment, in use, upon hearing of a hurricane or approaching storm with high winds rain or snow, the cover assembly may be fastened to the through the wall PTAC sleeve by placing the unit over the sleeve, wrapping the strap around the unit and tightening the ratchet strap around the cover and sleeve. The cover assembly may prevent driving rain snow and wind from entering the through the wall PTAC unit from the exterior of the building.

The cover assembly is easy to install, by a two-step process, placement of the cover and tightening of the securement component. The cover assembly is easily stored and available for use and installation when needed. The cover assembly saves time and money.

In summary, the present invention provides a storm cover assembly for through the wall air conditioning (PTAC) or other opening in a building.

It should be understood, of course, that the foregoing relates to exemplary embodiments of the invention and that modifications, variations and changes in detail may be made without departing from the spirit and scope of the invention as set forth in the following claims.

What is claimed is:

1. A cover assembly for covering an opening on or in a building wall, the cover assembly comprising:
a cover member; and
a securement element;
the cover assembly being constructed and arranged for placement of the cover member over the opening and placement of the securement element over and around the cover member and the opening.

2. The cover assembly of claim 1, wherein:
the cover member comprises an exterior portion, an interior portion, a front panel and at least one side panel attached to and extending perpendicularly from the front panel; and
the securement element further comprises an attachment assembly comprising a strap and a strap ratchet operably connected to the strap.

3. The cover assembly of claim 2 wherein:
the front panel is a rectangular panel, and the at least one side panel further comprises a top side panel, a right side panel, a left side panel, and a bottom side panel; and
the strap further comprises a first strap portion, a second strap portion and a third strap portion;
the attachment assembly further comprises a first strap attachment panel and a second strap attachment panel, the first strap attachment panel being attached to the first strap portion of the strap, the second strap attachment panel being attached to the second strap portion of the strap;
the first strap attachment panel and second strap attachment panel are fixedly mounted to the at least one side panel; and
the strap ratchet is attached to the third strap portion of the strap.

4. The cover assembly of claim 3 wherein the first strap attachment panel is attached to the right side panel and the second strap attachment panel is attached to the left side panel.

5. The cover assembly of claim 3 wherein the front panel is about 43″×18′ and the side panels are about 3″ wide.

6. The cover assembly of claim 2 wherein the cover member is constructed and arranged for placement over an opening selected from a window, an air conditioning sleeve, a split A/C unit, an Air Handler, an Exhaust Unit or an Intake Unit.

7. A cover assembly for covering an opening, the cover assembly comprising:
a rectangular cover member comprising an exterior portion, an interior portion, a rectangular front panel, and a rectangular side panel extending perpendicularly from the front panel, wherein the rectangular side panel further comprises a top side panel, a right side panel, a left side panel, and a bottom side panel; and
a securement element comprising an attachment assembly, the attachment assembly comprising: a strap having a first strap end, an intermediate strap portion, and a second strap end; a strap attachment panel attached to the first strap end of the strap, the strap attachment panel further being fixedly mounted to the rectangular side panel, and a strap ratchet operably connected to the strap, the strap ratchet being attached to the second strap end.

8. The cover assembly of claim 7 wherein the strap attachment panel is attached to the right side panel.
